(19) United States
(12) Patent Application Publication
(10) Pub. No.: US 2004/0080703 A1
(43) Pub. Date: Apr. 29, 2004

(54) Double-layered substrate structure for LCD and fabricating method thereof

(75) Inventors: Tzu-Yuan Lai, Taichung (TW); Dai-Liang Ting, Hsinchu (TW); Chi-Jain Wen, Hsinchu (TW)

Correspondence Address: QUINTERO LAW OFFICE, 1617 BROADWAY, 3RD FLOOR, SANTA MONICA, CA, 90404, US

(73) Assignee: Toppoly Optoelectronics Corp.

(21) Appl. No.: 10/458,343

(22) Filed: Jun. 10, 2003

(30) Foreign Application Priority Data
Oct. 24, 2002 (TW) 91124759

(51) Int. Cl. G02F 1/1339

(52) U.S. Cl. 349/153

(57) ABSTRACT

A double-layered substrate structure for LCD and fabricating method thereof. The fabricating method of the double-layered substrate structure includes providing a double-layered substrate structure having a plurality of liquid crystal cells therein, forming a first seal pattern along the periphery of the liquid crystal cells, wherein the first seal pattern has a notch in each liquid crystal cell for liquid crystal injection, and forming a second seal pattern along the periphery of the double-layered substrate structure, thereby protecting the liquid crystal cells from contamination. Contamination during shipping of the double-layered substrate structure is avoided, and the liquid crystal cells are well-protected during thinning of the glass substrates.

### BACKGROUND OF THE INVENTION

1. Field of the Invention

The present invention relates to a liquid crystal display and fabricating method thereof, and more particularly to a double-layered substrate structure for LCD.

2. Description of the Related Art

Liquid crystal display (LCD) is a commonly used flat panel technology. Owing to dielectric anisotropy and conductive anisotropy of liquid crystal molecules, molecular orientation of liquid crystals can be shifted under an external electronic field, such that various optical effects are produced.

An LCD panel is generally made up of two substrates, with a gap preserved therebetween, and a liquid crystal layer filled within the gap. Respective electrodes are formed on the two substrates, respectively, to control the orientation and shift of liquid crystal molecules.

A TFT (thin film transistor) LCD panel is generally made up of a TFT array substrate and a color filter substrate. The two substrates are first manufactured separately, then aligned and joined together. During the combining of the two substrates, generally referred to as cell process, spacers are spread over the liquid crystal chips to maintain and even the cell gap between the two substrates, and a seal pattern is formed along the periphery of each liquid crystal chip to adhere the two substrates after curing, sustaining the two-layered unit. Afterwards, the two-layered unit is broken to divide each liquid crystal chip into an independent double-layered unit, having a notch therebetween for liquid crystal injection. The notch is then sealed after injection of liquid crystals to complete the fabrication of the LCD panel.

In the current cell process of LCD, the steps of two-substrate alignment and break are generally performed in a clean room of a single fab to avoid yield loss resulting from contamination of the double-layered substrate structure. However, taking into account the large occupation of the automatic glass-breaking machine and high cost of clean room and maintenance, an improved alternative is to reduce the manufacturing cost by separating the two steps, therefore a method allowing shipping of the double-layered substrate structure, from the clean room where the alignment is performed to another place where the break is performed, is needed.

Owing to the increase in potential contamination sources during shipping, it is important to prevent the double-layered substrate structure from contamination, thereby lowering the risks of yield loss.

### SUMMARY OF THE INVENTION

Accordingly, an object of the present invention is to provide a double-layered substrate structure and the fabricating method thereof, thereby preventing the double-layered substrate structure from contamination and lowering the risk of yield loss.

Therefore, the invention provides a double-layered substrate structure for LCD, whereby contamination is prevented, comprising a double-layered substrate structure having a plurality of liquid crystal cells formed therein, a first seal pattern along the periphery of the liquid crystal cells, wherein the first seal pattern has a notch in each liquid crystal cell for liquid crystal injection, and a second seal pattern along the periphery of the double-layered substrate structure, thereby protecting the liquid crystal cells from contamination.

The invention further provides a fabricating method of a double-layered substrate structure for LCD, wherein a seal pattern is formed in the periphery of the double-layered substrate structure, thereby isolating the interior from the environment and lowering the risk of contamination. The method comprises providing a double-layered substrate structure having a plurality of liquid crystal cells formed therein, forming a first seal pattern along the periphery of the liquid crystal cells, wherein the first seal pattern has a notch in each liquid crystal cell for liquid crystal injection, and forming a second seal pattern along the periphery of the double-layered substrate structure, thereby protecting the liquid crystal cells from contamination.

According to the invention, the second seal pattern can be a closed pattern, thereby completely isolating the interior from the environment without concern for environmental contamination. In addition, the process can be further integrated with the thinning of glass substrate substrates. In the thinning of glass substrate substrates, the upper or lower glass substrate of the double-layered substrate structure is polished or etched to reduce thickness, thereby reducing the total thickness of the double-layered substrate structure and providing lighter weight. In the present invention, the interior of the double-layered substrate structure is completely isolated from the environment, thereby avoiding contamination during polishing or etching and better serving integration with the thinning process.

According to the invention, the second seal pattern can be, rather than a closed pattern, a fringe pattern having an opening as a vent to facilitate breaking of the double-layered substrate structure and overcome difficulties therewith resulting from the closed pattern. In this case, the opening of the second seal pattern can be on any side of the double-layered substrate structure, but is preferably on the same side as the notches of the first seal pattern to achieve better ventilating effect.

According to the invention, a third seal pattern can be formed in the vicinity of the notches of the second seal pattern to protect the liquid crystal cells from contamination, wherein the third seal pattern can be striped, extending perpendicular to the notches of the second seal pattern.

According to the invention, the first, second and third seal patterns are made of low-permeability sealant, wherein the materials thereof can be the same.

### DESCRIPTION OF THE DRAWINGS

The present invention can be more fully understood by reading the subsequent detailed description and examples with references made to the accompanying drawings, wherein:

FIG. 1 shows the alignment of a double-layered substrate structure;

FIG. 2 illustrates the seal patterns applied in the first embodiment;

FIG. 3 illustrates the seal patterns applied in the second embodiment;

FIG. 4 illustrates the seal patterns applied in the third embodiment; and

FIG. 5 illustrates the seal patterns applied in the fourth embodiment.

### DETAILED DESCRIPTION OF THE INVENTION

In the embodiments, the first, second and third seal patterns are preferably made of low-permeability material, wherein the materials thereof can be the same, for example, UV curable or thermocurable sealant, such as epoxy and polyacrylate.

First Embodiment

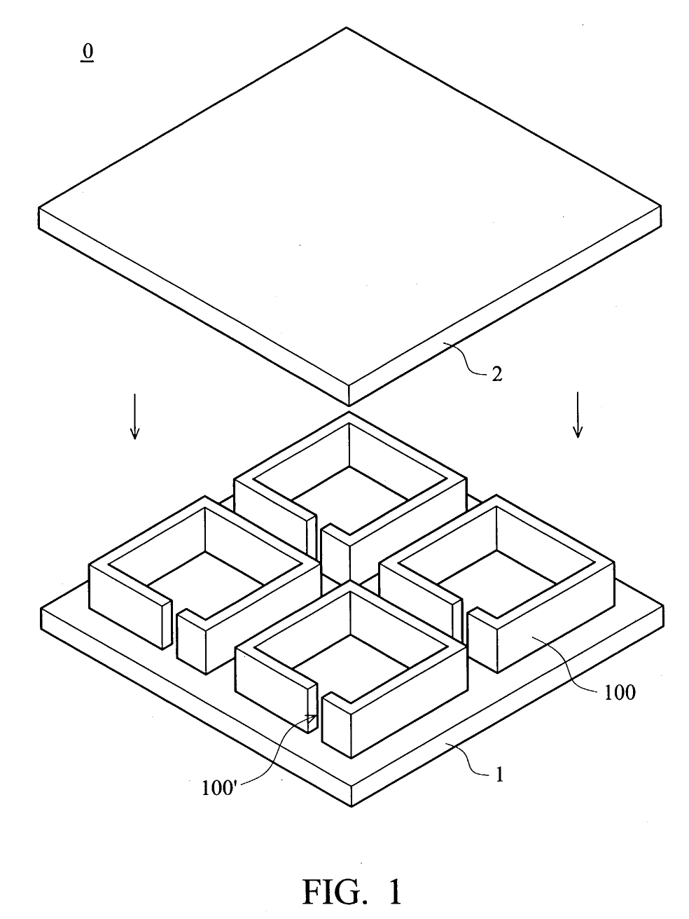

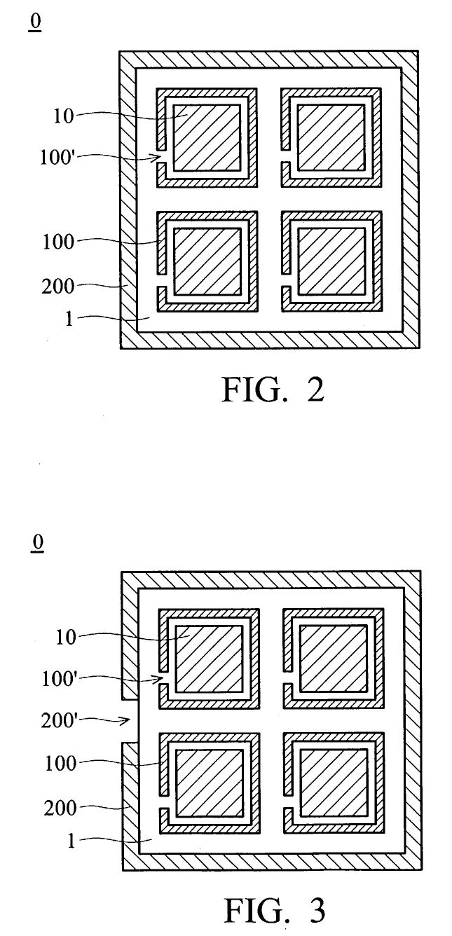

In FIG. 1, a double-layered substrate structure 0, made up of a glass substrate 1 and another glass substrate 2, is provided. FIG. 2 illustrates the seal patterns applied therein. A plurality of liquid crystal cells 10 consisting of a color filter (not shown) and TFTs (not shown) are formed in the double-layered substrate structure 0, with a first seal pattern 100 along the periphery thereof, wherein the first seal pattern 100 has a notch 100′ for liquid crystal injection. Each notch 100′ of the first seal pattern 100 faces the same direction. The two glass substrates 1 and 2 are then aligned and combined. A second seal pattern 200 is then formed along the periphery of the double-layered substrate structure 0 to seal it completely, isolating the interior of the double-layered substrate structure 0 from the environment to avoid contamination. The first seal pattern 100 and the second seal pattern 200 are then cured to increase the strength, thereby enhancing support of the glass substrates.

Second Embodiment

In FIG. 1, a double-layered substrate structure 0, made up of a glass substrate 1 and another glass substrate 2, is provided. FIG. 3 illustrates the seal patterns applied therein. A plurality of liquid crystal cells 10 consisting of a color filter (not shown) and TFTs (not shown) are formed in the double-layered substrate structure 0, with a first seal pattern 100 along the periphery thereof, wherein the first seal pattern 100 has a notch 100′ for liquid crystal injection. Each notch 100′ of the first seal pattern 100 faces the same direction. The two glass substrates 1 and 2 are then aligned and combined. A second seal pattern 200, having an opening 200′ for ventilation, is then formed along the periphery of the double-layered substrate structure 0. The opening 200′ can be formed on any side of the double-layered substrate structure 0, for example, on the side and perpendicular to the notches of the first seal pattern, or on the side parallel thereto. The opening 200′ is preferably formed on the corresponding side of the notch 100′. The second seal pattern 200 protects the interior of the double-layered substrate structure 0 from contamination and facilitates the break process of the double-layered substrate structure 0 by way of the opening 200′. The first seal pattern 100 and the second seal pattern 200 are then cured to increase the strength, thereby enhancing support of the glass substrates.

Third Embodiment

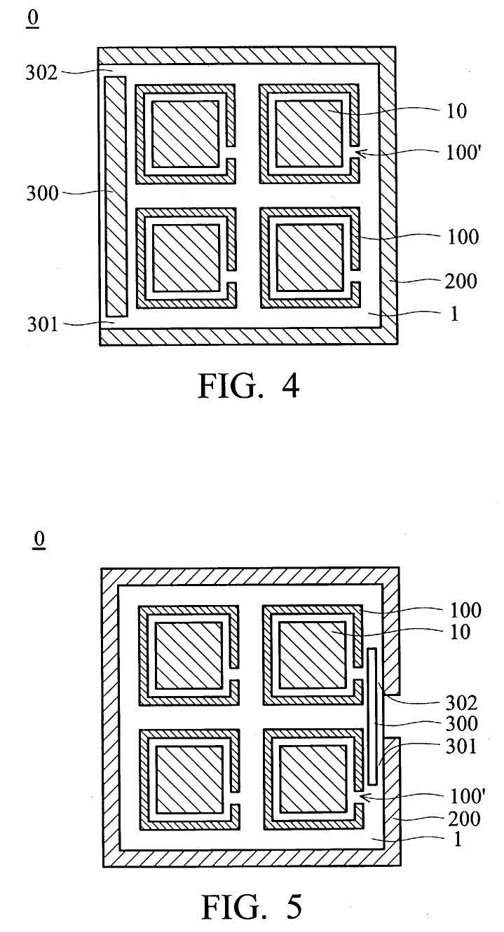

In FIG. 1, a double-layered substrate structure 0, made up of a glass substrate 1 and another glass substrate 2, is provided. FIG. 4 illustrates the seal patterns applied therein. A plurality of liquid crystal cells 10 consisting of a color filter (not shown) and TFTs (not shown) are formed in the double-layered substrate structure 0, with a first seal pattern 100 along the periphery thereof, wherein the first seal pattern 100 has a notch 100′ for liquid crystal injection. Each notch 100′ of the first seal pattern 100 faces the same direction. A third seal pattern 300 is then formed along a side, contrary to the notch 100′, of the double-layered substrate structure 0. The two glass substrates 1 and 2 are then aligned and combined. A second seal pattern 200, having an opening side for ventilation, is then formed along the periphery of the double-layered substrate structure 0, except the side where the third seal pattern 300 has been formed, thereby forming vents 301 and 302. The second seal pattern 200 protects the interior of the double-layered substrate structure 0 from contamination and facilitates the break process of the double-layered substrate structure 0 by way of the vents 301 and 302. The first seal pattern 100 and the second seal pattern 200 are then cured to increase the strength, thereby enhancing support of the glass substrates.

Fourth Embodiment

In FIG. 1, a double-layered substrate structure 0, made up of a glass substrate 1 and another glass substrate 2, is provided. FIG. 5 illustrates the seal patterns applied therein. A plurality of liquid crystal cells 10 consisting of a color filter (not shown) and TFTs (not shown) are formed in the double-layered substrate structure 0, with a first seal pattern 100 along the periphery thereof, wherein the first seal pattern 100 has a notch 100′ for liquid crystal injection. Each notch 100′ of the first seal pattern 100 faces the same direction. A third seal pattern 300 is then formed along a side, corresponding to the notch 100′, of the double-layered substrate structure 0. The two glass substrates 1 and 2 are then aligned and combined. A second seal pattern 200, having an opening for ventilation, is then formed along the periphery of the double-layered substrate structure 0, wherein the opening and the third seal pattern 300 are on the same side, thereby forming vents 301 and 302. The second seal pattern 200 protects the interior of the double-layered substrate structure 0 from contamination and facilitates the break process of the double-layered substrate structure 0 by way of the vents 301 and 302. The first seal pattern 100 and the second seal pattern 200 are then cured to increase the strength, thereby enhancing support of the glass substrates.

The foregoing description has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A double-layered substrate structure for LCD, whereby contamination is prevented, comprising:
a double-layered substrate structure having a plurality of liquid crystal cells formed therein;
a first seal pattern along the periphery of the liquid crystal cells, wherein the first seal pattern has a notch in each liquid crystal cell for liquid crystal injection; and
a second seal pattern along the periphery of the double-layered substrate structure, thereby protecting the liquid crystal cells from contamination.

2. The double-layered substrate structure as claimed in claim 1, wherein the double-layered substrate structure is formed by a first glass substrate provided with a color filter and a second glass substrate provided with thin film transistors.

3. The double-layered substrate structure as claimed in claim 1, wherein the second seal pattern is formed thoroughly along the periphery of the double-layered substrate structure to seal the double-layered substrate structure.

4. The double-layered substrate structure as claimed in claim 1, wherein the second seal pattern has a notch.

5. The double-layered substrate structure as claimed in claim 4, wherein the notches of the second seal pattern faces parallel to the direction of the notches of the first seal pattern.

6. The double-layered substrate structure as claimed in claim 4, wherein the notches of the second seal pattern is perpendicular to the notches of the first seal pattern.

7. The double-layered substrate structure as claimed in claim 4, further comprising a third seal pattern in the vicinity of the notches of the second seal pattern, protecting the liquid crystal cells from contamination.

8. The double-layered substrate structure as claimed in claim 7, wherein the third seal pattern is striped, extending perpendicular to the notches of the second seal pattern.

9. The double-layered substrate structure as claimed in claim 7, wherein the third seal pattern is made of low-permeability sealant.

10. The double-layered substrate structure as claimed in claim 4, wherein the second seal pattern is made of low-permeability sealant.

11. A fabricating method of a double-layered substrate structure for LCD, comprising:
providing a double-layered substrate structure having a plurality of liquid crystal cells therein;
forming a first seal pattern along the periphery of the liquid crystal cells, wherein the first seal pattern has a notch in each liquid crystal cell for liquid crystal injection; and
forming a second seal pattern along the periphery of the double-layered substrate structure, thereby protecting the liquid crystal cells from contamination.

12. The fabricating method as claimed in claim 11, wherein the double-layered substrate structure is formed by a first glass substrate provided with a color filter and a second glass substrate provided with thin film transistors.

13. The fabricating method as claimed in claim 11, wherein the second seal pattern is formed thoroughly along the periphery of the double-layered substrate structure to seal the double-layered substrate structure.

14. The fabricating method as claimed in claim 11, wherein the second seal pattern has a notch.

15. The fabricating method as claimed in claim 14, wherein the notches of the second seal pattern faces parallel to the notches of the first seal pattern.

16. The fabricating method as claimed in claim 14, wherein the notches of the second seal pattern is perpendicular to the notches of the first seal pattern.

17. The fabricating method as claimed in claim 14, further comprising a step of forming a third seal pattern in the vicinity of the notches of the second seal pattern, protecting the liquid crystal cells from contamination.

18. The fabricating method as claimed in claim 17, wherein the third seal pattern is striped, extending perpendicular to the notches of the second seal pattern.

19. The fabricating method as claimed in claim 17, wherein the third seal pattern is made of low-permeability sealant.

20. The fabricating method as claimed in claim 14, wherein the second seal pattern is made of low-permeability sealant.
